(19) United States
(12) Patent Application Publication
(10) Pub. No.: US 2025/0280288 A1
(43) Pub. Date: Sep. 4, 2025

(54) DYNAMIC USER ACCESS CONTROL AND CREDENTIAL MANAGEMENT IN WIRELESS AMBIENT POWER (AMP) DEVICES

(71) Applicant: Cypress Semiconductor Corporation, San Jose, CA (US)

(72) Inventors: Hui Luo, Marlboro, TX (US); Rakesh Taori, McKinney, TX (US)

(73) Assignee: Cypress Semiconductor Corporation, San Jose, CA (US)

(21) Appl. No.: 18/594,786

(22) Filed: Mar. 4, 2024

(51) Int. Cl. H04W 12/03; H04W 12/041; H04W 12/084; H04W 12/106; H04W 12/71; H04W 12/72

(52) U.S. Cl. CPC H04W 12/03; H04W 12/041; H04W 12/084; H04W 12/106; H04W 12/71; H04W 12/72

(57) ABSTRACT

A method for transmitting, by a powered wireless device, an identification (ID) request frame to an ambient power (AMP) device that harvests environmental energy. Receiving, at the powered wireless device an ID response frame from the AMP device in response to the ID request frame. The ID response frame includes an ID of the AMP device, and a network address of a network server. The powered device securely communicates with the network server using the network address to obtain authorization and data from the network server with which to establish an encrypted wireless communication session with the AMP device identified by the ID of the AMP device.

### TECHNICAL FIELD

This disclosure relates to wireless devices and, more specifically, to dynamic user access control and credential management in wireless ambient power (AMP) devices.

### BACKGROUND

Radio frequency (RF) wireless devices have grown in type and capability. In some wireless local area networks (WLANs), ambient power (AMP) devices, which harvest energy from the environment, can be effectively deployed as low cost wireless data collection sensors. Some use cases include tagging containers of retail products traveling from and between warehouses and tagging luggage being transported from and between air transportation and within airports. Other use cases include tracking or reporting environmental data such as temperature, proximity, pressure, or light data collected by a sensor.

Due to the limited power available for processing incoming requests, communications with AMP devices are not secured. The limited power availability also restricts the ability of AMP devices to change communication parameters in the field, such as parameters related to access permissions (e.g., which devices can connect to the AMP devices). For example, writing to memory can require more power than is available to the AMP device, and so changing communication parameters may only be possible when external power is applied to the AMP device (e.g., when the AMP device is not deployed in an operational network). Thus, communication parameters of AMP devices that harvest energy from the environment, such as user access rights, may not be able to be practically reconfigured after the AMP devices are deployed in an operational network.

### BRIEF DESCRIPTION OF THE DRAWINGS

FIG. 1 is a block diagram of an exemplary wireless network configured with RF band arrangements for downlink and uplink transmissions between a powered wireless device and an AMP device according to various embodiments.

FIG. 2A, is a flow diagram of an example method for dynamic user access control and credential management in wireless AMP devices, according to aspects of the disclosure.

FIG. 2B is a flow diagram of an example method for dynamic user access control and credential management in wireless AMP devices, according to some aspects of the disclosure.

FIG. 2C is a flow diagram of an example method for dynamic user access control and credential management in wireless AMP devices, according to some aspects of the disclosure.

FIG. 3A, is a flow diagram of a method for dynamic user access control and credential management in wireless AMP devices, according to some aspects of the disclosure.

FIG. 3B is a flow diagram of an example method for dynamic user access control and credential management in wireless AMP devices, according to some aspects of the disclosure.

FIG. 3C is a flow diagram of an example method for dynamic user access control and credential management in wireless AMP devices, according to some aspects of the disclosure.

FIG. 4 is a flow diagram of a method for dynamic user access control and credential management in wireless AMP devices, according to other aspects of the disclosure.

FIG. 5 is a flow diagram of a method for dynamic user access control and credential management in wireless AMP devices, according to still other aspects of the disclosure.

FIG. 6 is a simplified block diagram of an example wireless device, which may represent any of the powered wireless device or client wireless devices discussed herein according to aspects of the disclosure.

### DETAILED DESCRIPTION

The following description sets forth numerous specific details such as examples of specific systems, devices, components, methods, and so forth, in order to provide a good understanding of various embodiments of mutual authentication and encryption key generation in wireless ambient power (AMP) devices. Some wireless AMP devices, e.g., AMP wireless clients, are simple wireless devices needing little processing power and memory, and thus can operation with little power. These AMP devices harvest (or scavenge) energy from the environment sufficient for brief and reduced processing. For example, AMP devices may communicate an identifier (ID) and/or other data being gathered by a sensor of or that is coupled to the AMP device. Powered wireless devices, such as routers, access points, client devices, etc., may be so referenced within mesh networks because the devices are receiving external continuous power, in contrast to AMP devices which do not receive continuous external power.

As discussed previously, due to the limited power available for receiving and processing incoming requests, as well as processing and transmitting outgoing responses, communication sessions with wireless AMP devices (e.g., also referred to herein as “AMP devices”) are often unencrypted. Often, establishing and maintaining an encrypted communication session requires each device participating in the encrypted communication session to maintain constant communication. This type of constant communication is not always possible or feasible for an AMP device. Further, typical communication in a WLAN between wireless clients and powered wireless devices requires extensive handshake protocols to ensure authentication and verification of connected devices (e.g., to establish a secured network or wireless communication session) in addition to encryption of data exchanged between the AMP wireless clients and powered wireless devices (e.g., once the secured wireless communication session is established). For example, many encryption methods can require two devices to transmit several frames of data in order to authorize each device, then several frames to establish an encryption (e.g., determine respective encryption keys) and then one or more frames to transmit and receive encrypted data. These more extensive protocol-based attachment methods are inconsistent with the low-power nature of the AMP devices due to the amount of power required. Without encryption, AMP devices may not be deployed in many practical settings, due to the risk of transmitting and receiving unencrypted data, which risks are increasingly of concern related to Internet of Things (IoT) devices.

Aspects of the present disclosure resolve these and other deficiencies with known approaches to employing AMP devices in WLAN-based systems, by providing a method for dynamic user access control and credential management in wireless ambient power (AMP) devices. In some embodiments, the present disclosure provides various methods and systems in which powered wireless devices can initiate and establish an encrypted communication session with an AMP device with a minimal exchange of data exchange frames. In some embodiments, authentication and key generation may be embedded in a brief data exchange, thus eliminating the need for any extra frame exchanges for establishing a secure association state. In some embodiments, authentication and key generation for the powered wireless device can be performed by a network server communicatively coupled to the powered wireless device. The network server can authorize, on behalf of a particular powered wireless device, a communication between the AMP device and the particular powered wireless device. Thus, the network server can provide the AMP device with the functionality of dynamic user access control and credential management of powered wireless devices.

For example, in some embodiments, the network server, on behalf of the powered wireless device, generates an encryption key before mutual authentication, just at the time when the powered wireless device needs the encryption key to encrypt a data request frame. Later, the powered wireless device-to-AMP device authentication can be performed at the AMP device after the AMP device receives the encrypted data request frame. In the same manner, key generation at the AMP device can be performed before mutual authentication, just at the time when the AMP device needs the encryption key to encrypt a data response frame. Later, the AMP device-to-powered wireless device authentication can be performed at the powered wireless device (e.g., using information obtained from the securely coupled network server) after the powered wireless device receives the data response frame. At this point, in at least some embodiments, the one-shot encrypted data exchange finishes and the mutual authentication finishes at the same time.

In some embodiments, for example, authentication information and encryption key information is embedded into the data exchange frames that contain encrypted data. In this way, authentication between the devices can be accomplished at the same time that encrypted data is transmitted, thus reducing the quantity of frames required to transmit/receive an authenticated and encrypted communication. That is, the AMP device can receive encrypted data from the powered wireless device before the AMP device has authorized the powered wireless device, and similarly, the powered wireless device can receive encrypted data from the AMP device before the powered wireless device has authorized the AMP device. The powered wireless device can perform an additional operation to authorize the AMP device (e.g., by communicating with a network server that has a shared secret with the AMP device).

More specifically, the AMP device can receive encrypted data from the powered wireless device alongside authorization information for the powered wireless device. The AMP device can authorize the powered wireless device as an authorized sender, decrypt the encrypted data, and send encrypted data and authorization information to the powered wireless device in a quick series of low-power processing operations. This series of quick operations can reduce the time the AMP device needs to maintain power. The powered wireless device can receive encrypted data from the AMP device, authorize the AMP device as an authorized sender with the help of the network server, and decrypt the encrypted data.

In some embodiments, the network server can receive an access request packet from the powered wireless device (regarding an AMP device). The network server can determine (e.g., based on access tables, etc.) whether the powered wireless device is authorized to communicate with the AMP device. If the powered wireless device is authorized to communicate with the AMP device, the network server can use a secret shared with the AMP device to determine authentication and key management (AKM) parameters with which the powered wireless device can initiate an encrypted communication with the AMP device. In some embodiments, the shared secret is negotiated based on a networking protocol, pre-programmed to the AMP device and/or powered wireless device during manufacturing, or otherwise configured before deployment of the AMP device and/or powered wireless device in an operational network. In some embodiments, the network server generates an encryption key. The network server can communicate the AKM parameters to the powered wireless device in a data access response packet. Once the powered wireless device receives the AKM parameters (and in some embodiments, the encryption key), the powered wireless device can transmit, to the AMP device, a data request including encrypted data and at least one of the AKM parameters received from the network server.

In related embodiments, for example, the powered wireless device is configured to transmit an identification request frame to an AMP device. The powered wireless device can receive an identification response frame from the AMP device that includes the first AKM parameters, an ID of the AMP device, and a network address of a network server. After the identification response frame is verified, the powered wireless device can transmit an access request packet to the network server requesting authorization to initiate an encrypted communication with the AMP device. The powered wireless device can receive second AKM parameters and an encryption key from the network server. In some embodiments, the powered wireless device can further transmit a data request and receive a respective data response using a similar approach that will be discussed in more detail.

In some embodiments, for example, an AMP device is configured to receive an identification request frame from a powered wireless device. After the identification request frame has been verified by the AMP device, the AMP device uses a secret that is shared with a network server to determine authentication and key management (AKM) parameters. The AMP device can send the AKM parameters to the powered wireless device along with a network address of a network server and an ID of the AMP device. The powered wireless device can use the AKM parameters and ID of the AMP device to obtain second AKM parameters and an encryption key from the network server. In some embodiments, the AMP device further receives a data request from the powered wireless device containing the AKM parameters and encrypted data and transmits a respective data response with requested data or information.

Advantages of the present disclosure include, but are not limited to, providing user access control for encrypted communication sessions between powered wireless devices and AMP devices within a WLAN-based system, despite the fact that the AMP devices are able to operate infrequently, at low power, and with minimal stored data. The addition of an authentication network server allows the AMP device to store, and subsequently transmit, a static network address (e.g., a uniform resource locator (URL) or other network address) to the network server with which the network server can determine whether the powered wireless device is authorized to communicate with the AMP device. As such, the AMP device is not performing the dynamic user access control, which could have power requirements that exceed the power available to the AMP device. Additional advantages will be apparent to those skilled in the art of WLAN-related data collection and tracking systems that employ AMP devices, and are further discussed below.

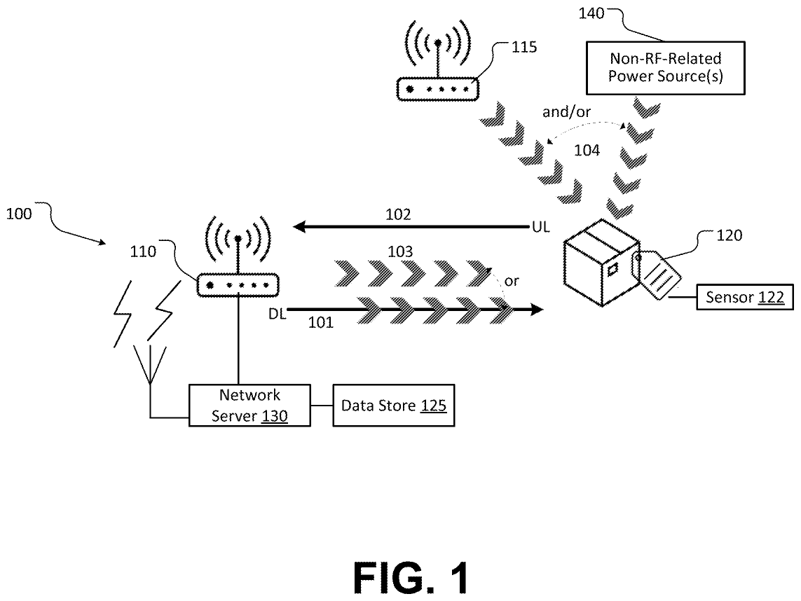

FIG. 1 is a block diagram of an exemplary wireless network 100 configured with RF band arrangements for downlink (DL) and uplink (UL) transmissions between a powered wireless device 110 and an AMP device 120, e.g., AMP client wireless device, according to various embodiments. In some embodiments, the powered wireless device 110 is an access point, a router, a wireless hub, a mobile hotspot device, or a wireless (or cellular) base station, a client device, or the like that is externally powered. In some embodiments, the powered wireless device 110 can be externally powered by a direct current (DC) voltage sources and/or alternating current (AC) power sources. For example, the powered wireless device 110 can be externally powered by DC power source such as a battery (e.g., a laptop, or mobile phone battery). In another example, the powered wireless device 110 can be externally powered by an AC power source such as a wall socket, or building mains voltage. In various embodiments, the AMP device 120 is a wireless identification tag or a low-power client wireless device or AMP station (STA). As illustrated, the wireless network 100 can include a second powered wireless device 115, a data store 125, and a non-RF-related power source 140.

In some embodiments, the powered wireless device 110 communicates to a network server 130 to upload data to a cloud. In some embodiments, the network server 130 can be a WLAN network server. In these embodiments, the network server 130 includes or is coupled to a data store 125 of volatile or non-volatile memory, e.g., within cloud-based storage that exists in a local cloud or edge cloud or the like. In this way, data/information collected by the powered wireless device 110 can be stored, by the network server 130, in the data store 125 where the data can optionally be indexed against respective AMP devices 120, e.g., in a database or the like. In various embodiments, the data or information collected and stored includes an identification and/or a location of the AMP device 120, temperature data, humidity data, pressure data, level data (e.g., level of fluid or gas within a container), and/or other data associated with an environment of the AMP device 120. In some embodiments, the data or information is a log or array of information to include a data history of the AMP device 120 that includes environmental data or information collected over time. The sensor-related data may be detected from a sensor 122 (or multiple sensors) included within or coupled to the AMP device 120.

In some embodiments, the network server 130 can perform one or more authentication operations on behalf of the powered wireless device. The network server 130 can determine whether the powered wireless device 110 is authorized to communicate with the AMP device 120. If the powered wireless device 110 is authorized to communicate with the AMP device 120, the network server 130 can provide communication parameters to the powered wireless device 110 for the communication between the powered wireless device 110 and the AMP device 120. In some embodiments, the communication parameters can include one or more AKM parameters, an encryption key, temporary secrets, or other indicators that cause the powered wireless device 110 to initiate an encrypted wireless communication session with the AMP device 120.

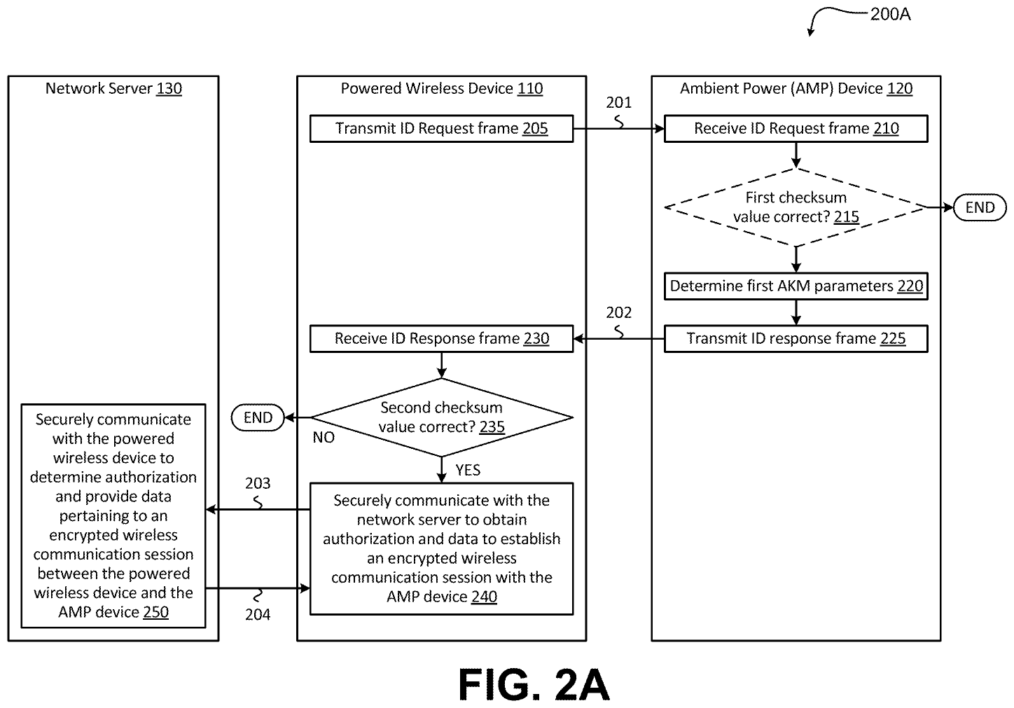

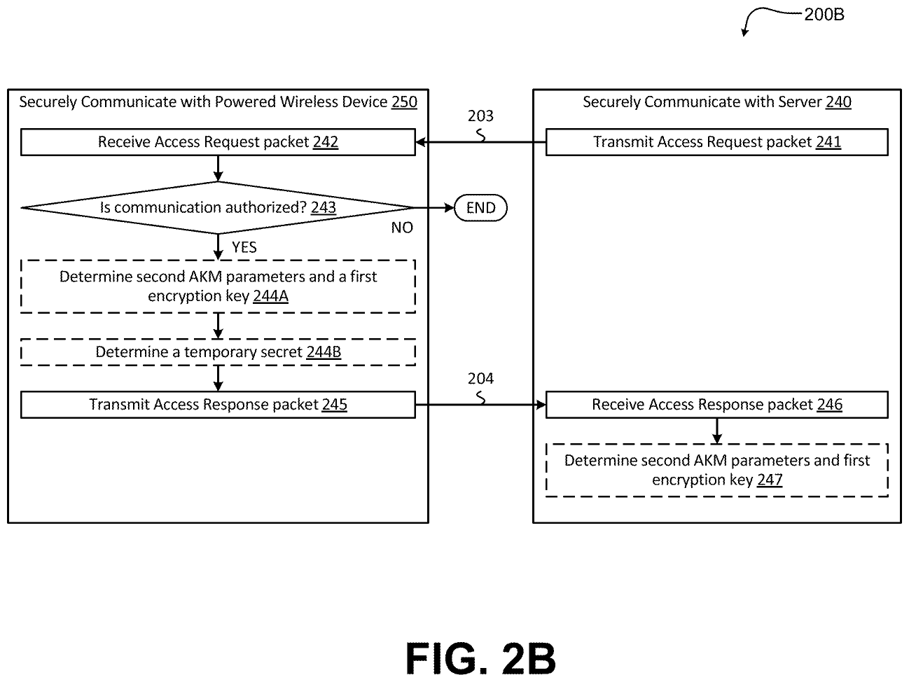

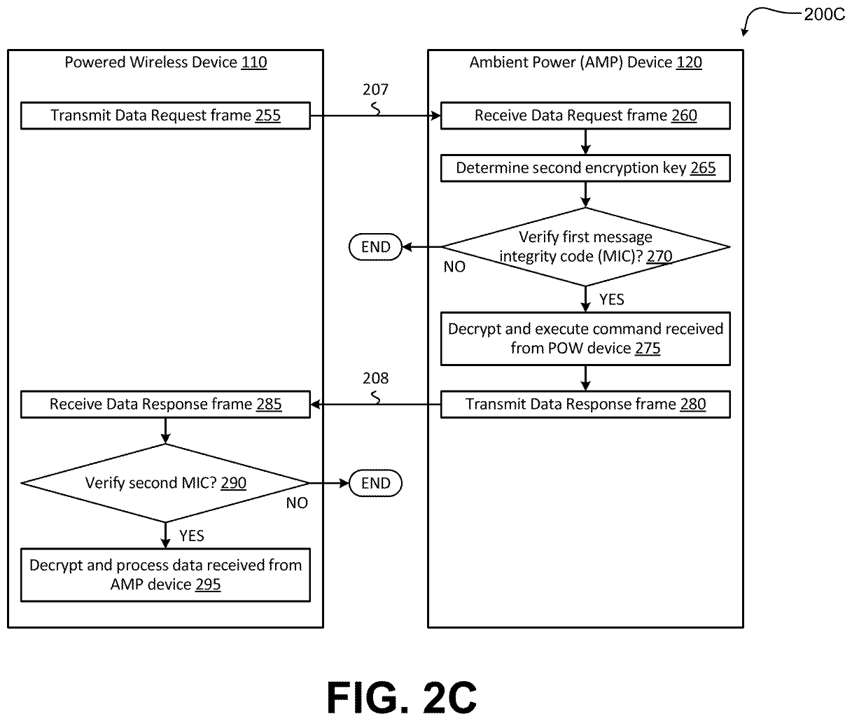

In some embodiments, the network server 130 determines whether the powered wireless device 110 is authorized to communicate with the AMP device 120 based on an ID of the AMP device 120 and an ID associated with the powered wireless device 110 (e.g., a user ID). For example, the powered wireless device 110 can be directed to the network server 130 by the AMP device 120 (e.g., using a network address such as a URL) when the powered wireless device 110 initiates a procedure to establish an encrypted wireless communication session with the AMP device 120. The powered wireless device 110 can request authorization from the network server 130 to communicate with the AMP device 120. If the network server 130 determines the powered wireless device 110 is authorized to communicate with the AMP device 120, the network server 130 can provide one or more authentication and key management (AKM) parameters, an encryption key, and/or a temporary secret to the powered wireless device 110. The temporary secret can be used by the powered wireless device 110 to generate the one or more AKM parameters and/or an encryption key. Additional details are described below in FIGS. 2A-5.

In many embodiments, there are one or more powered wireless devices 110 and many client wireless devices, which are AMP devices 120, as disclosed herein. Ambient power (AMP) devices are energized by harvesting energy from RF signals (e.g., RF-related power sources) and/or from non-RF-related power sources 140 (e.g., the AMP device can harvest environmental energy). In various embodiments, harvested energy from RF-related power sources are from in-band RF power sources (e.g., within the same RF band being used for downlink/uplink (DL/UL) transmissions) or out-of-band RF power sources (e.g., downlink (DL) and uplink (UL) transmissions take place in different RF bands compared to RF band being used for energy harvesting). In additional embodiments, non-RF-related power sources include solar or photovoltaic cells (convert ambient sunlight into electricity), thermoelectric generators (convert temperature gradients into electricity), vibration energy harvesting using piezoelectric, electrostatic, and electromagnetic converters (convert mechanical vibrations from the environment into electricity), miniature wind turbines (convert ambient wind energy into electrical power), pressure differential energy harvesting, dynamos or wearable harvesters (convert human or animal motion into electrical energy), and other such energy-harvesting mechanisms. In some embodiments, the AMP device can harvest environmental energy using one or more collection circuits (e.g., AMP collection circuits). The collection circuits can include circuitry that can harvest any of the above-mentioned electrical potential energy (e.g., the collection circuit can be configured to harvest environmental energy).

In some embodiments, the powered wireless device 110 does not transmit the energizing RF signal. For example, in other embodiments, the wireless network 100 further includes a second powered wireless device 115 and/or non-RF-related power sources 140 that provide RF power and/or non-RF power, respectively, from which the AMP device 120 harvests environmental energy (e.g., from power sources other than from the powered wireless device 110 associated with the DL/UL transmissions). In at least some embodiments, the second powered wireless device 115 transmits an energizing RF signal (104) towards the client wireless device from which the client wireless device harvests energy. In further embodiments, the energizing signals (101) or (103) discussed with reference to FIG. 1A are combined with the energizing RF signal (104) of FIG. 1B. Further, non-RF-related energy harvesting may be employed alone or in combination with RF-related energy harvesting.

With additional reference to FIG. 1, in at least one embodiment, the powered wireless device 110 transmits a first wireless signal (101), which is a DL transmission, over a first RF band to the AMP device 120. In some embodiments, the first wireless signal includes a data packet requesting information from the AMP device 120. The AMP device 120 may receive the first wireless signal and parse the data packet to determine the requested information.

In these embodiments, the AMP device 120 transmits a second wireless signal (102), which is an UL transmission, over a second RF band to the powered wireless device 110 with a data packet with the requested information. In this way, the requested information or data (discussed previously) may be requested and received from the AMP device 120 through data packet exchange. In various embodiments, the powered wireless device 110 generates the first wireless signal employing technology such as Wi-Fi®, Bluetooth®, Bluetooth® Low Energy, Ultra-Wideband (UWB), Z-wave™, Zigbee®, LoRa™, Wi-SUN®, or other wireless protocol. In various embodiments, the AMP device 120 generates the second wireless signal employing technology such as Wi-Fi®, Bluetooth®, Bluetooth® Low Energy, Ultra-Wideband (UWB), Z-wave™, Zigbee®, LoRa™, Wi-SUN®, or other wireless protocol.

In some embodiments, the first RF band for DL transmission differs from the second RF band used for UL transmission. In some embodiments, the second RF band operates at a lower frequency range than that of the first RF band, e.g., as low frequencies consume less power. Lower frequencies also exhibit smaller path losses compared to higher frequencies and, at the same power, the wireless signals can be adequately received and decoded at a farther distance and propagate through or around obstacles better compared to higher frequencies. Further, RF and circuit design at lower frequencies can be far less complex compared to being designed for at higher frequency operation, keeping costs low for the AMP devices.

In some embodiments, the second RF band operates at a higher frequency range than that of the first RF band, e.g., higher frequency operations deploy wider channel bandwidths, which in turn allow a transmission of the same number of user bytes and finish earlier. The AMP device 120 may then receive and/or transmit for a shorter period of time, conserving power and providing a separate power consumption benefit. Accordingly, use of a higher frequency range or a lower frequency range with the UL transmission (compared to the DL transmission) may involve a cost-benefit analysis that weighs these benefits as between higher or lower frequency ranges.

In other embodiments, the first RF band is the same as the second RF band, but the DL transmission and the UL transmission occur over different frequencies with significant separation (e.g., more than a few 100 megahertz (MHz) within that same RF band. In these ways, both the technology and RF bands (or frequencies) can differ as between the DL/UL transmissions so that AMP devices can operate at lower power while avoiding frequency conflicts between the DL and UL transmissions.

In various embodiments, the first wireless signal (101), e.g., transmitted in the first RF band, is also an energizing RF signal, illustrated with thick directional indicators, from which the AMP device 120 harvests environmental energy. In similar embodiments, the powered wireless device 110 instead transmits a separate energizing RF signal (103) towards the AMP device 120, but this separate energizing RF signal (103) is also within the first RF band, e.g., is not necessarily the same as the first wireless signal (101), but may be close in frequency. In alternative embodiments, the separate energizing RF signal (103) is transmitted over the second RF band, e.g., of the UL transmission, or is transmitted over an entirely different third RF band. Accordingly, in differing embodiments, the energizing RF signal (103) is sent over the first RF band, the second RF band, or the third RF band. For example, in some embodiments by way of example, the first RF band is 5.0 gigahertz (GHz), the second RF band may be 2.4 GHz, and the third RF band may be 5.0 or 6.0 GHz, where the third RF band may also be employed by the powered wireless device 110 to communicate with other mobile stations (STA).

Data can be communicated between the powered wireless device 110, and the AMP device 120 as frames in a request-and-response protocol. The request-and-response protocol can be based on a secret that is shared between the network server 130 and the AMP device 120, as described above. The secret can be stored in the data store 125 (or other secure location) and programmed to the AMP device 120 during manufacturing or before deployment within an operational network.

In some embodiments, the request-and-response protocol between the powered wireless device 110 and the AMP device 120 is compatible with the carrier sense multiple access with collision avoidance (CSMA/CA) network protocol. In some embodiments, the request-and-response protocol between the powered wireless device 110 and the AMP device 120 is compatible with the request-to-send/clear-to-send (RTS/CTS) network protocol. In some embodiments, the request-and-response protocol between the powered wireless device 110 and the AMP device 120 is compatible with backscattering.

Frames can include information organized into five fields, as shown in Table 1:

TABLE 1

| First Field | Second Field | Third Field | Fourth Field | Fifth Field |
|---|---|---|---|---|
| Recipient ID | Sender ID | Frame Type | Data Body | Frame Check |
| | | | | Data |

In various embodiments, the first field of the frame includes the recipient ID (e.g., the ID of the powered wireless device 110, or the ID of the AMP device 120). In some embodiments, the recipient ID is the media access control (MAC) address of the recipient device. In alternative embodiments, the recipient ID is a unique, pre-assigned ID, e.g., assigned at manufacturing or before deployment within an operational network. For example, in some embodiments, power harvested by the AMP device 120 is insufficient to perform program operations on non-volatile memory, and the AMP device 120 can have a unique ID programmed into non-volatile memory at an initial factory setup with external power. Requests received at the AMP device 120 can have the ID of the AMP device 120 in the first field. Responses received at the powered wireless device 110 can have the ID of the powered wireless device 110 in the first field. In some embodiments, the recipient ID identifies a particular subset of recipient devices (e.g., multiple AMP devices 120).

For example, the recipient ID can be a subset of MAC addresses (e.g., a MAC multicast address) corresponding to the particular subset of AMP devices. In some embodiments, the recipient ID identifies any recipient device (e.g., any AMP device 120) within a wireless connection range of a sender device (e.g., the powered wireless device 110). For example, the recipient ID can be a MAC broadcast address, such as FF:FF:FF:FF:FF:FF.

In various embodiments, the second field of the frame includes the sender ID (e.g., the ID of the powered wireless device 110, or the ID of the AMP device 120). The characteristics of the sender ID can be the same as, or similar to, the characteristics described above with reference to the recipient ID. Requests sent from the powered wireless device 110 can have the ID of the powered wireless device 110 in the second field. Responses sent from the AMP device 120 can have the ID of the AMP device 120 in the second field.

In various embodiments, the third field of the frame includes the frame type, which can identify the type of frame, e.g., ID request frame, ID response frame, data request frame, data response frame. In some embodiments, the frame type identified in the third field is based on or defines information located in the data body of the fourth field.

In various embodiments, the fourth field of the frame includes the data body, which can include frame-exchange parameters, data, commands, authentication and key management (AKM) parameters (e.g., Simultaneous Authentication of Equals (SAE)), cipher suites (e.g., Advanced Encryption Standard (AES), such as AES 1280 bit (AES128)), physical layer (PHY) parameters for guiding frame transmission to reduce conflicts, and session information (e.g., a session number). In some embodiments, some portions of the data body can be secured, such as by encryption or hashing.

In some embodiments, the AKM parameters can include one or more cryptographic parameters. In some embodiments, the AKM parameters include a scalar value that can be an input into an encryption algorithm and an element value that can be an output of the encryption algorithm. In some embodiments, the encryption algorithm is associated with an elliptical curve, where the scalar value denotes a position on the elliptical curve, and the element value represents the position on the elliptical curve that is selected by the scalar value.

In various embodiments, the fifth field of the frame includes frame check data. The frame check data can be any data that can be used by the receiving device (e.g., the powered wireless device 110 or the AMP device 120 respectively) to verify that the frame was received without errors or modification. In some embodiments, the frame check data can include unsecured error check data such as checksum data, cyclic redundancy check (CRC) data, or secured (e.g., encrypted or hashed) error check data such as message integrity code (MIC) data depending on the application and level of network attachment.

FIG. 2A, is a flow diagram of an example method 200A for dynamic user access control and credential management in wireless AMP devices, according to some aspects of the disclosure. The method 200A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200A can be performed by processing logic of the powered wireless device 110, processing logic of the AMP device 120, and/or processing logic of the network server 130.

At operation 210, the processing logic of the powered wireless device 110 transmits an ID request frame 201 to the AMP device 120 that harvests environmental energy. In some embodiments, the ID request frame 201 includes one or more frame-exchange parameters. In some embodiments, the frame-exchange parameters include a session number. The session number can be a unique identifier for the communication session that is initiated with by sending the ID request frame 201. If the communication session terminates (e.g., the method 200A ends), the session number can be discarded. Upon re-initiating a communication session with another ID request frame (not illustrated), a new session number can be selected. In some embodiments, the ID request frame can include a checksum or other error-checking value or method, such as a cyclic redundancy check (CRC). In some embodiments, the powered wireless device 110 sends multiple ID request frames 201 on different channels of a wireless network to ascertain the working channel of the AMP device 120.

At operation 215, the processing logic of the AMP device 120 receives the ID request frame 201 from the powered wireless device 110. In some embodiments, the processing logic of the AMP device 120 verifies whether the error-checking value of the received ID request frame 201 is correct. If the error-checking value is not correct, the method 200A ends, e.g., the processing logic of the AMP device 120 terminates a procedure of establishing an authenticated and encrypted network session with the powered wireless device. If the error-checking value is correct, the processing logic of the AMP device 120 proceeds to operation 225.

At operation 220, the processing logic of the AMP device 120 determines first authentication and key management (AKM) parameters for the AMP device 120. In some embodiments, the first AKM parameters are determined based on the secret that is shared between the AMP device 120 and the network server 130. In some embodiments, the first AKM parameters include a first scalar value and a first element value. The first scalar value can be a value selected by the AMP device 120 and used as input to a cryptographic algorithm to produce the first element value.

In some embodiments, the first AKM parameters can be selected based on one or more AKM methods. In some embodiments, the AMP device 120 can select an AKM method for the secure communication session. For example, in response to receiving an ID request frame 201, the processing logic of the AMP device 120 can select an AKM method for which to determine first AKM parameters (e.g., prior to or while performing operation 225). In some embodiments, the AMP device 120 is pre-programmed to operate with a specific AKM method. AKM methods can include one or more of a password-based challenge and response, simultaneous authentication of equals (SAE), public/private key trust method (e.g., using security certificates), or the like. In some embodiments, the AKM method is based on a cipher block, where data is encrypted in fixed-size blocks (e.g., 64 bits, 128 bits, etc.) Plaintext is divided into blocks and each block is independently encrypted using the same encryption key, where each the encryption of each block can be dependent on the encryption of a previous block. In alternative embodiments, the AKM method is based on a cipher stream, where data is encrypted bit by bit. Plaintext is combined with a pseudorandom stream of bits (e.g., cyphertext) using a bitwise exclusive-or (XOR) function.

At operation 225, the processing logic of the AMP device 120 transmits an ID response frame 202 to the powered wireless device 110. In some embodiments, the ID response frame 202 includes an ID of the AMP device, a network address of the network server 130 (e.g., a uniform resource locator (URL) address), and CRC data (or another form of error-checking data). In some embodiments, the ID response frame 202 includes one or more first AKM parameters, one or more frame-exchange parameters, and/or a nonce value generated by the AMP device 120 based on the secret shared between the AMP device 120 and the network server 130. The frame-exchange parameters can include the session number (e.g., the session number of operation 210). The one or more first AKM parameters included in the ID response frame 202 can be a first scalar value and a first element value.

At operation 230, the processing logic of the powered wireless device 110 receives an ID response frame 202 from the AMP device 120.

At operation 235, the processing logic of the powered wireless device 110 verifies the CRC data of the received ID response frame 202. If the processing logic cannot verify the CRC data, the method 200A ends, e.g., the processing logic of the powered wireless device 110 terminates a procedure of establishing an authenticated and encrypted network session with the AMP device. If the processing logic can verify the CRC data, the processing logic of the powered wireless device 110 proceeds to operation 240.

At operation 240, the processing logic of the powered wireless device 110 securely communicates with the network server 130 by sending an access request packet 203 to obtain authorization and data to establish an encrypted wireless communication session with the AMP device 120. In some embodiments, securely communicating with the network server 130 includes establishing a secure connection with the network server 130 using security protocols, such as any of Hypertext Transfer Protocol Secure (HTTPS), Authentication Authorization and Accounting (AAA) frameworks, Secure Socket Layer (SSL), Transport Layer Security (TLS), Internet Protocol Security (IPSec), Secure Shell (SSH), Zero Trust, and/or any combination thereof, prior to receiving the access request packets 203 or transmitting the access response packets 204.

At operation 250, the processing logic of the network server 130 securely communicates with the powered wireless device 110 by sending an access response packet 204 to determine authorization and provide data pertaining to an encrypted wireless communication session between the powered wireless device 110 and the AMP device 120. In some embodiments, securely communicating with the powered wireless device 110 includes establishing a secure connection with the network server 130 using security protocols, such as one or more of those discussed with reference to operation 240, prior to receiving the access request packets 203 or transmitting the access response packets 204.

FIG. 2B, is a flow diagram of an example method 200B for dynamic user access control and credential management in wireless AMP devices, according to some aspects of the disclosure. The method 200B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200B can be performed by processing logic of the powered wireless device 110, processing logic of the AMP device 120, and/or processing logic of the network server 130. In some embodiments, the method 200B is a continuation of the method 200A.

In some embodiments, the operations 240 and 250 (e.g., the powered wireless device 110 and the network server 130 securely communicating the access request packet 203 and the access response packet 204) can further include the operations 241-247.

At operation 241, the processing logic of the powered wireless device 110 can transmit an access request packet 203. The access request packet can include an ID of the AMP device 120 and a user ID corresponding to the powered wireless device 110. In some embodiments, the access request packet can further include one or more authentication and key management (AKM) parameters, one or more user credentials corresponding to the user ID, and/or a nonce value generated at the AMP device 120. The nonce value can be generated based on the secret shared between the AMP device 120 and the network server 130.

At operation 242, the processing logic of the network server 130 can receive the access request packet. In some embodiments, the processing logic of the network server 130 can determine whether the access request packet includes the one or more AKM parameters. In some embodiments, the processing logic of the network server 130 can determine whether the access request packet includes the nonce value.

At operation 243, the processing logic of the network server 130 can determine whether communication between the powered wireless device 110 and the AMP device is authorized. If the processing logic of the network server 130 determines that communication between the powered wireless device 110 and the AMP device 120 is not authorized, the method 200B ends, e.g., the procedure for establishing an authenticated and encrypted wireless communication session between the powered wireless device 110 and the AMP device 120 is terminated.

In some embodiments, the processing logic of the network server 130 maintains a data table of user IDs that are authorized to communicate with respective AMP IDs. In some embodiments, the data table can be stored at data store 125 (described with reference to FIG. 1).

In some embodiments, the network server 130 can include a user authentication module or process that authorizes a powered wireless device 110 to access a respective AMP device (based on the ID of the AMP device) responsive to the user ID and corresponding user credentials satisfying a user credential criterion. For example, a user ID and password (e.g., corresponding user credential) can be authenticated by the network server 130, and the network server 130 can determine that the powered wireless device 110 associated with the user ID is thus authorized to communicate with the AMP device 120. The authentication parameters and/or tables stored on the network server 130 that correspond to the AMP device 120 (based on the ID of the AMP device 120) can be changed based on user access requirements and credential management parameters for the AMP device 120.

For example, an organization with multiple powered wireless devices 110 can deploy multiple AMP devices 120. Because the AMP devices 120 lack sufficient power to be reprogrammed while deployed in an operational network, changes to access permissions (e.g., whether a particular powered wireless device is authorized to communicate with a particular AMP device) cannot be executed at the AMP device 120. Instead, the static network address programmed to the particular AMP devices can point to the network server 130, and a portion of the network server 130 associated with the ID of the particular AMP device can store a programmable authentication table identifying particular powered wireless devices (or user IDs) that are authorized to communicate with the particular AMP device. If a new user or powered wireless device 110 is added to the organization, the authentication table for the particular AMP device can be updated to reflect whether the new user or powered wireless device 110 is authorized to communicate with the particular AMP device. In some embodiments, one programmable authentication table is maintained for multiple AMP devices. In some embodiments, if the processing logic of the network server 130 identifies the user ID (or other identifier) corresponding to the powered wireless device 110 in the programmable authentication table, the processing logic of the network server 130 can determine that the powered wireless device 110 is authorized to communicate with the AMP device 120.

Operations 244A and 244B are alternative operations that follow operation 243. In some embodiments, operation 244A is performed following operation 243. In alternative embodiments, operation 244B is performed following operation 243.

At operation 244A, the processing logic of the network server 130 can determine second AKM parameters and a first encryption key. In some embodiments, operation 244A is performed when the access request packet 203 includes one or more first AKM parameters. The processing logic of the network server 130 can determine the second AKM parameters using the first AKM parameters received from the powered wireless device 110 (e.g., in the access request packet), and the secret shared with the AMP device 120 (e.g., the secret shared between the network server 130 and the AMP device 120). The processing logic of the network server 130 can further determine a first encryption key using at least the second AKM parameters.

At operation 244B, the processing logic of the network server 130 can determine a temporary secret. In some embodiments, operation 244B is performed when the access request packet 203 includes the nonce value generated by the AMP device 120. The processing logic of the network server can determine a temporary secret using at least the nonce value and the secret shared with the AMP device 120 (e.g., a primary secret shared between the network server 130 and the AMP device 120).

At operation 245, the processing logic of the network server 130 can transmit an access response packet 204 to the powered wireless device 110. In some embodiments, the access response packet 204 includes the one or more second AKM parameters and encryption key determined by the network server 130. In some embodiments, the access response packet 204 includes the temporary secret determined by the network server 130. In some embodiments, the access response packet 204 includes an indicator that the powered wireless device 110 is authorized to initiate an encrypted wireless communication session with the AMP device 120.

At operation 246, the processing logic of the powered wireless device 110 receives the access response packet 204.

At alternative operation 247, responsive to receiving an access response packet 204 containing a temporary secret, the processing logic of the powered wireless device 110 determines AKM parameters using at least the temporary secret received from the network server 130. In some embodiments, the processing logic of the powered wireless device 110 determines the one or more AKM parameters using the temporary secret and previously received AKM parameters from the AMP device 120. The processing logic of the powered wireless device 110 can further determine a first encryption key using at least the determined AKM parameters (e.g., the AKM parameters determined using the temporary secret). In some embodiments, the processing logic of the powered wireless device 110 determines the first encryption key using the previously received AKM parameters (e.g., first AKM parameters) and the determined AKM parameters (e.g., second AKM parameters).

It can be noted that in most embodiments, if processing logic of the network server 130 performs operation 244A, then processing logic of the powered wireless device 110 will not perform operation 247. Similarly, in most embodiments, if processing logic of the network server 130 performs operation 244B, then processing logic of the powered wireless device 110 will perform operation 247.

FIG. 2C, is a flow diagram of an example method 200C for dynamic user access control and credential management in wireless AMP devices, according to some aspects of the disclosure. The method 200C can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200C can be performed by processing logic of the powered wireless device 110, processing logic of the AMP device 120, and/or processing logic of the network server 130. In some embodiments, the method 200C is a continuation of the method 200B and/or a continuation of the method 200A.

At operation 255, the processing logic of the powered wireless device 110 transmits a data request frame 207 to the AMP device 120. In some embodiments, the data request frame 207 includes one or more frame-exchange parameters, one or more second AKM parameters, a first message integrity code (MIC), and a command. In some embodiments, processing logic of the powered wireless device 110 generates the first MIC using a first portion of the first encryption key. In some embodiments, the command is encrypted. In some embodiments, processing logic of the powered wireless device 110 encrypts the command using a second portion of the first encryption key. In some embodiments, the frame-exchange parameters include a cipher type (e.g., a cipher suite). The cypher type can be associated with an AKM method. In some embodiments, the cipher type is associated with a cipher algorithm (as described above). The powered wireless device 110 can select the AKM method. In some embodiments, the AMP device 120 selects the AKM method.

At operation 260, the processing logic of the AMP device 120 receives the data request frame 207 from the powered wireless device 110.

At operation 265, the processing logic of the AMP device 120 determines a second encryption key for the AMP device 120. In some embodiments, the second encryption key for the AMP device 120 is determined from information received in the data request frame 207. In some embodiments, the second encryption key for the AMP device 120 is determined from the first AKM parameters of the AMP device 120 and the second AKM parameters received in the data request frame 207.

At operation 270, the processing logic of the AMP device 120 verifies the first message integrity code (MIC) of the data request frame 207. If the first MIC cannot be verified, the method 200C ends, e.g., the processing logic of the AMP device 120 terminates an encrypted network session initiated with the powered wireless device 110. If the first MIC is verified, the processing logic of the AMP device 120 proceeds to operation 275. In some embodiments, the processing logic of the AMP device 120 uses a first portion of the second encryption key to verify the first MIC.

At operation 275, the processing logic of the AMP device 120 decrypts the encrypted command received from the powered wireless device 110 to generate a decrypted command. Also at operation 275, the processing logic of the AMP device 120 executes the decrypted command, which may include generating a data response frame 208. In some embodiments, the processing logic of the AMP device 120 uses a second portion of the second encryption key to decrypt the encrypted command received in the data request frame 207.

At operation 280, the processing logic of the AMP device 120 transmits a data response frame 208 to the powered wireless device 110. In some embodiments, the data response frame 208 includes at least one of the one or more frame-exchange parameters, a second MIC, and data including at least status or environmental data retrieved from a coupled sensor (or the like). In some embodiments, the processing logic of the AMP device 120 generates the second MIC using a first portion of the second encryption key. In some embodiments, the data is encrypted. The processing logic of the AMP device 120 can encrypt the data using a second portion of the second encryption key.

At operation 285, the processing logic of the powered wireless device 110 receives the data response frame 208 from the AMP device 120.

At operation 290, the processing logic of the powered wireless device 110 verifies the second MIC of the data response frame 208. If the second MIC cannot be verified, the method 200C ends, e.g., the processing logic of the powered wireless device 110 terminates the encrypted network session with the AMP device 120. If the second MIC is verified, processing logic of the powered wireless device 110 proceeds to operation 295. In some embodiments, the processing logic of the powered wireless device 110 uses a first portion of the first encryption key to verify the second MIC.

At operation 295, the processing logic of the powered wireless device 110 decrypts the encrypted data received from the AMP device 120 to generated decrypted data. Also at operation 295, the processing logic of the powered wireless device 110 processes the decrypted data received from the AMP device 120 in the data response frame 208. In some embodiments, the processing logic of the powered wireless device 110 uses a second portion of the first encryption key to decrypt the encrypted data received in the data response frame 208.

In some embodiments, the processing logic of the powered wireless device 110 determines whether to request additional data from the AMP device 120 (not illustrated). Upon determining to request additional data from the AMP device 120, the processing logic of the powered wireless device 110 can transmit a second data request frame (not illustrated) to the AMP device 120 e.g., similar to operation 255. The second data request frame can include at least one of the one or more frame-exchange parameters, a third MIC, and a second command. The processing logic of the AMP device 120 can receive the second data request frame, and verify the third MIC of the second data request frame, e.g., similar to operations 255 and 265, respectively. If the MIC cannot be verified, the method 200C ends, e.g., the processing logic of the AMP device 120 terminates the encrypted network session initiated with the powered wireless device 110. If the third MIC is verified, the processing logic of the AMP device 120 can decrypt and execute the command received in the second data request, e.g., similar to operation 275. The processing logic of the AMP device 120 can transmit a second data response frame (not illustrated) to the powered wireless device 110. The second data response frame can include at least one of the one or more frame-exchange parameters a fourth MIC, and second data. The processing logic of the powered wireless device 110 can receive the second data response frame, and verify the fourth MIC of the second data response frame, e.g., similar to operations 280 and 285, respectively. If the MIC cannot be verified, the method 200C ends, e.g., the processing logic of the powered wireless device 110 terminates the encrypted network session initiated with the AMP device 120. If the fourth MIC is verified, the processing logic of the powered wireless device 110 can decrypt and process the data received in the second data response frame, e.g., similar to operation 295. In some embodiments, additional data requests and corresponding data responses can be transmitted and received until the powered wireless device 110 determines that no more data is to be collected from the AMP device 120, the AMP device 120 loses power, or the communication session otherwise terminates, e.g., the method 200C ends.

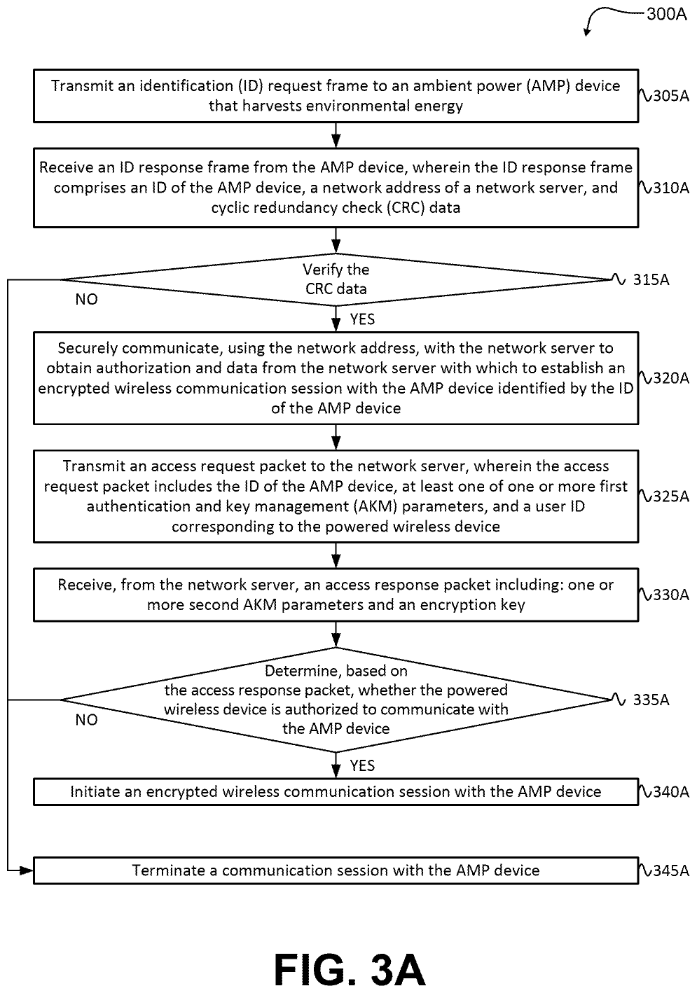

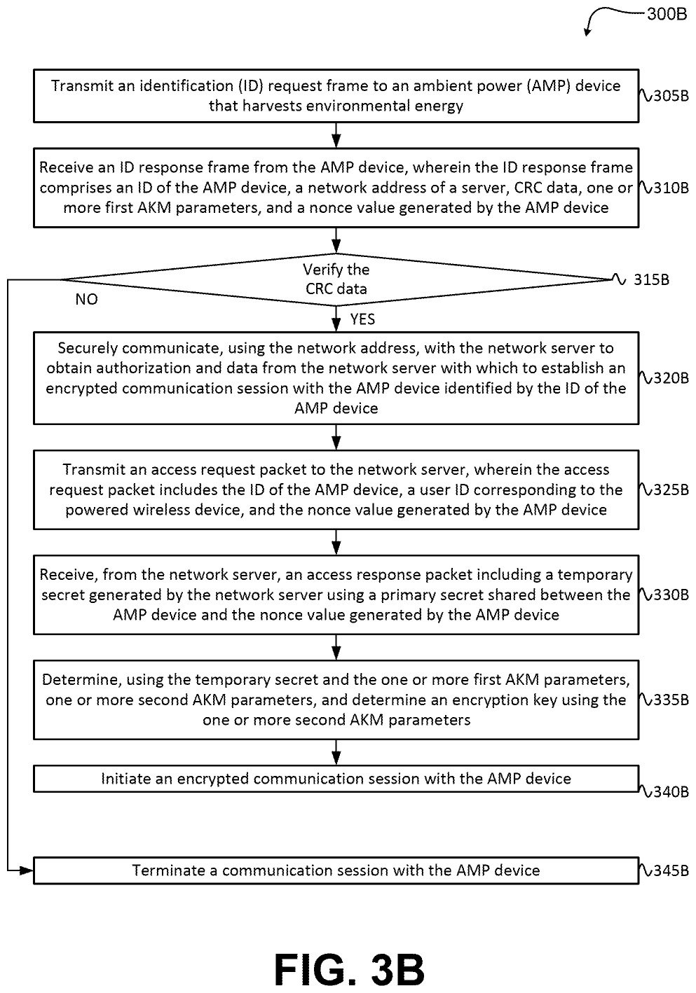

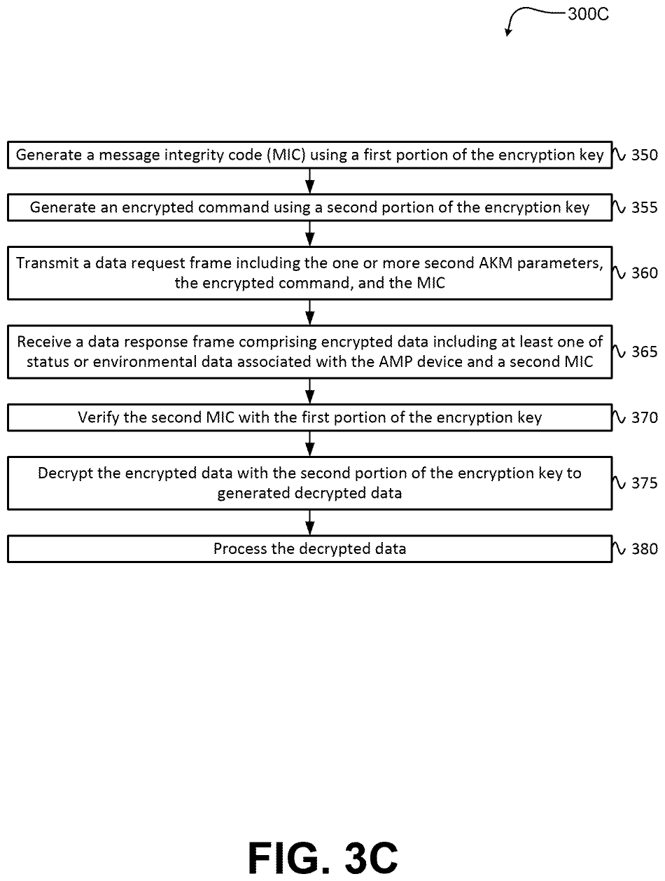

FIG. 3A is a flow diagram of an example method 300A for dynamic user access control and credential management in AMP devices, according to some aspects of the disclosure. The method 300A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300A can be performed by the wireless network 100, e.g., processing logic of the powered wireless device 110. FIG. 3A and FIG. 3B include many of the the same operations, e.g., operations 305A, 315A, 320A, 340A, and 345A.

At operation 305A, the processing logic causes the powered wireless device 110 to transmit an identification (ID) request frame to an ambient power (AMP) device that harvests environmental energy. In some embodiments, the ID request frame includes one or more frame-exchange parameters and a checksum value. In some embodiments, the ID response frame can further include a frame type. In some embodiments, the one or more frame-exchange parameters include a frame type, a session number, and physical layer (PHY) parameters. In some embodiments, the processing logic causes the powered wireless device 110 to perform subsequent operations (e.g., operations 310A-345A).

At operation 310A, following operation 305A, the processing logic causes the powered wireless device 110 to receive an ID response frame from the AMP device. The ID response frame can include an ID of the AMP device, a network address of network server, and cyclic redundancy check (CRC) data.

At operation 315A, the processing logic verifies the CRC data received from the AMP device 120 in the ID response frame. If the CRC data is verified, the processing logic proceeds to operation 315A. If the CRC data cannot be verified correct, the processing logic proceeds to operation 345A, where the communication session with the AMP device 120 can be terminated.

In some embodiments at operation 345A, responsive to failing to verify the checksum value, the processing logic terminates a procedure of establishing an authenticated and encrypted network session with the AMP device.

At operation 320A, the processing logic causes the powered wireless device 110 to securely communicate, using the network address, with the network server to obtain authorization and data from the network server with which to establish an encrypted wireless communication session with the AMP device identified by the ID of the AMP device.

At operation 325A, following operation 320A, the processing logic causes the powered wireless device 110 to transmit an access request packet to the network server. The access request packet can include the ID of the AMP device, at least one of one or more first authentication and key management (AKM) parameters, and a user ID corresponding to the powered wireless device. In some embodiments, the one or more first AKM parameters include one or more of Simultaneous Authentication of Equals (SAE) information, a password-based challenge, an ID, or information for another type of encryption. In some embodiments where the secret describes an elliptical curve, the one or more AKM parameters include a scalar value corresponding to a random, or pseudo-random number and an element value corresponding to a location along the elliptical curve selected using the scalar value (e.g., the random or pseudo-random number).

At operation 330A, following operation 325A, the processing logic causes the powered wireless device 110 to receive, from the network server, an access response packet including one or more second AKM parameters and an encryption key. The one or more second AKM parameters can be generated by the network server using a primary secret shared between the network server and the AMP device and at least one of the one or more first AKM parameters. The encryption key can be generated by the network server using at least one of the one or more second AKM parameters.

At operation 335A, following operation 330A, the processing logic determines, based on the access response packet, whether the powered wireless device 110 is authorized to communicate with the AMP device 120.

At operation 340A, the processing logic causes the powered wireless device 110 to initiate an encrypted wireless communication session with the AMP device 120.

At operation 345A, as described above, the method 300A can terminate if any of the preceding operations fail, e.g., at operation 315A and/or operation 335A.

FIG. 3B is a flow diagram of an example method 300B for dynamic user access control and credential management in AMP devices, according to some aspects of the disclosure. The method 300B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300B can be performed by the wireless network 100, e.g., processing logic of the powered wireless device 110. As described above, FIG. 3A and FIG. 3B include many of the the same operations, e.g., operations 305B, 315B, 320B, 340B, and 345B.

At operation 305B, the processing logic causes the powered wireless device 110 to transmit an identification (ID) request frame to an ambient power (AMP) device that harvests environmental energy. In some embodiments, the ID request frame includes one or more frame-exchange parameters and a checksum value. In some embodiments, the ID response frame can further include a frame type. In some embodiments, the one or more frame-exchange parameters include a frame type, a session number, and physical layer (PHY) parameters. In some embodiments, the processing logic causes the powered wireless device 110 to perform subsequent operations (e.g., operations 310B-345B).

At operation 310B, following operation 305B, the processing logic causes the powered wireless device 110 to receive an ID response frame from the AMP device. The ID response frame can include an ID of the Amp device, a network address of a network server, CRC data, one or more first AKM parameters, and a nonce value generated by the AMP device.

At operation 315B, the processing logic verifies the CRC data received from the AMP device 120 in the ID response frame. If the CRC data is verified, the processing logic proceeds to operation 315B. If the CRC data cannot be verified correct, the processing logic proceeds to operation 345B, where the communication session with the AMP device 120 can be terminated. In some embodiments at operation 345B, responsive to failing to verify the checksum value, the processing logic terminates a procedure of establishing an authenticated and encrypted network session with the AMP device.

At operation 320B, the processing logic causes the powered wireless device 110 to securely communicate, using the network address, with the network server to obtain authorization and data from the network server with which to establish an encrypted wireless communication session with the AMP device identified by the ID of the AMP device.

At operation 325B, following operation 320B, the processing logic causes the powered wireless device 110 to transmit an access request packet to the network server. The access request packet can include the ID of the AMP device, a user ID corresponding to the powered wireless device, and the nonce value generated by the AMP device.

At operation 330B, following operation 325B, the processing logic receives, from the network server, an access response packet including a temporary secret generated by the network server using the nonce value generated by the AMP device and a primary secret shared between the network server and the AMP device.

At operation 335B, following operation 330B, the processing logic determines, using the temporary secret and the one or more first AKM parameters, one or more second AKM parameters. Also at operation 335B, the processing logic determines a first encryption key using the one or more second AKM parameters.

At operation 340B, the processing logic causes the powered wireless device 110 to initiate an encrypted wireless communication session with the AMP device 120.

At operation 345B, as described above, the method 300B can terminate if any of the preceding operations fail, e.g., at operation 315B and/or operation 335A.

FIG. 3C is a flow diagram of an example method 300C for dynamic user access control and credential management in AMP devices, according to some aspects of the disclosure. The method 300C can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300C can be performed by the wireless network 100, e.g., processing logic of the powered wireless device 110. In some embodiments, the method 300C is a continuation of the method 300A. In alternative embodiments, the method 300C is a continuation of the method 300B.

At operation 350, the processing logic generates a message integrity code (MIC) using a first portion of the encryption key. In some embodiments, the operation 350 follows the operation 340A. In some embodiments, the operation 350 follow the operation 340B.

At operation 355, the processing logic generates an encrypted command using a second portion of the encryption key.

At operation 360, the processing logic causes the powered wireless device 110 to transmit a data request frame to the AMP device 120, the data request frame including the one or more second AKM parameters, the encrypted command, and the MIC.

At operation 365, the processing logic causes the powered wireless device 110 to receive a data response frame from the AMP device 120, the data response frame including encrypted data and a second MIC. In some embodiments, the encrypted data includes at least one of status or environmental data associated with the AMP device 120 (e.g., collected by a sensor coupled to the AMP device 120).

At operation 370, the processing logic verifies the second MIC with the first portion of the encryption key.

At operation 375, the processing logic decrypts the encrypted data of the data response frame using the second portion of the encryption key to generate decrypted data.

At operation 380, the processing logic processes the decrypted data.

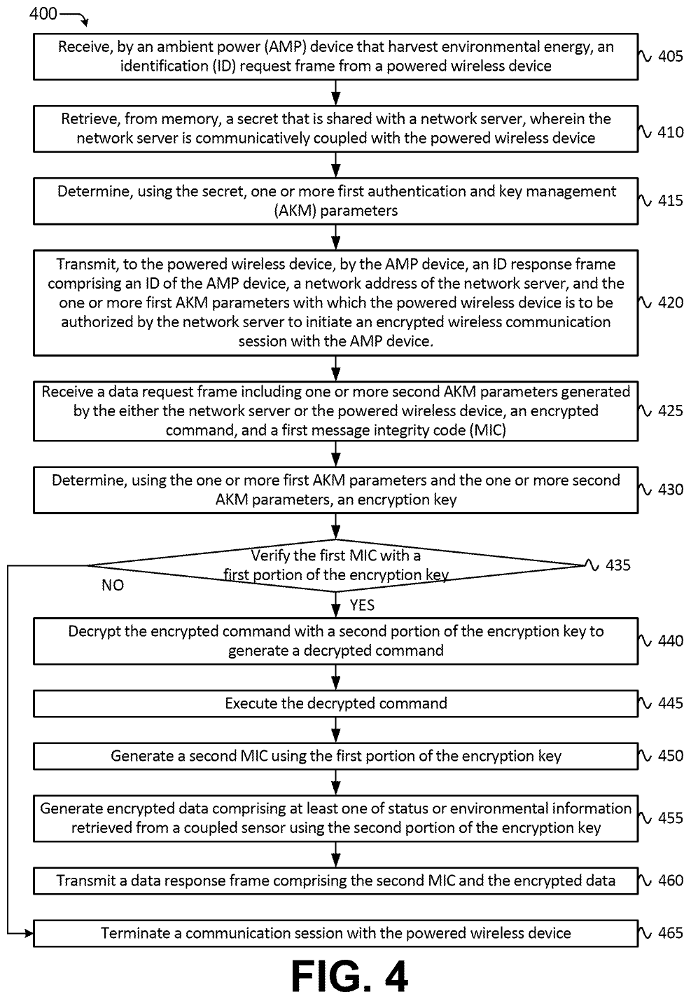

FIG. 4 is a flow diagram of an example method 400 for dynamic user access control and credential management in wireless AMP devices, according to other aspects of the disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. The method 400 can be performed by the wireless network 100 e.g., processing logic of the AMP device 120.

At operation 405, the processing logic causes the AMP device 120 to receive an ID request frame from a powered wireless device 110. In some embodiments, the ID request frame includes one or more frame exchange parameters. In some embodiments, the one or more frame-exchange parameters can include a frame type, a session number, and physical layer (PHY) parameters. In some embodiments, the one or more frame-exchange parameters include a first AMP device identifier corresponding to a first AMP device of many AMP devices. In some embodiments, the one or more frame-exchange parameters include a broadcast value comprising an identifier corresponding to multiple AMP devices that include the AMP device. In some embodiments, the ID request frame can further include a checksum value. In some embodiments, the processing logic causes the powered wireless device 110 to transmit the ID request and/or causes the powered wireless device 110 to perform subsequent operations (e.g., operation 410-450).

At operation 410, the processing logic retrieves, from memory, a secret that is shared with a network server (e.g., a secret that is shared between the AMP device 120 and the network server 130). The network server can be communicatively coupled with the powered wireless device 110. In some embodiments, the secret describes an elliptical curve.

At operation 415, the processing logic determines, using the secret, one or more authentication and key management (AKM) parameters. In some embodiments, the one or more AKM parameters include one or more of Simultaneous Authentication of Equals (SAE) information, a password-based challenge, an ID, or information for another type of encryption. In some embodiments where the secret describes an elliptical curve, the one or more AKM parameters include a scalar value corresponding to a random, or pseudo-random number and an element value corresponding to a location along the elliptical curve selected using the scalar value (e.g., the random or pseudo-random number).

At operation 420, the processing logic causes the AMP device 120 to transmit to the powered wireless device 110, an ID response frame including an ID of the AMP device, a network address of the network server, and the one or more AKM parameters with which the powered wireless device 110 is to be authorized by the network server 130 to initiate an encrypted wireless communication session with the AMP device 120.

At operation 425, the processing logic causes the AMP device 120 to receive a data request frame. The data request frame can include one or more second AKM parameters, an encrypted command, and a message integrity code (MIC). In some embodiments, the one or more second AKM parameters are generated by the network server 130. In some embodiments, the one or more second AKM parameters are generated by the powered wireless device 110.

At operation 430, the processing logic the processing logic determines, using the one or more second AKM parameters, an encryption key.

At operation 435, the processing logic verifies, using a first portion of the encryption key, whether the MIC. If the MIC is verified, processing logic proceeds to operation 440. If the MIC cannot be verified, processing logic proceeds to operation 465, where the communication session with the powered wireless device 110 can be terminated. In some embodiments, at operation 465, responsive to failing to verify the MIC with a first portion of the encryption key, processing logic terminates an encrypted network session initiated with the powered wireless device 110.

At operation 440, the processing logic decrypts the encrypted command with a second portion of the encryption key to generate a decrypted command.

At operation 445, the processing logic executes the decrypted command. In some embodiments, to execute the encrypted command processing logic generates a data response frame and causes the data response frame to be transmitted to the powered wireless device. The data response frame can include encrypted data. In some embodiments, the encrypted data can include at least one of a status or environmental data retrieved from a coupled sensor. In some embodiments, the data response frame can include a second MIC.

At operation 450, the processing logic generates a second MIC using the first portion of the encryption key.

At operation 455, the processing logic generates encrypted data comprising at least one of status or environmental information retrieved from a coupled sensor using the second portion of the encryption key.

At operation 460, the processing logic causes the AMP device 120 to transmit a data response frame to the powered wireless device 110. The data response frame can include the second MIC and the encrypted data.

At operation 465, as described above, the method 400 can terminate if any of the preceding operations fail, e.g., at operation 435.

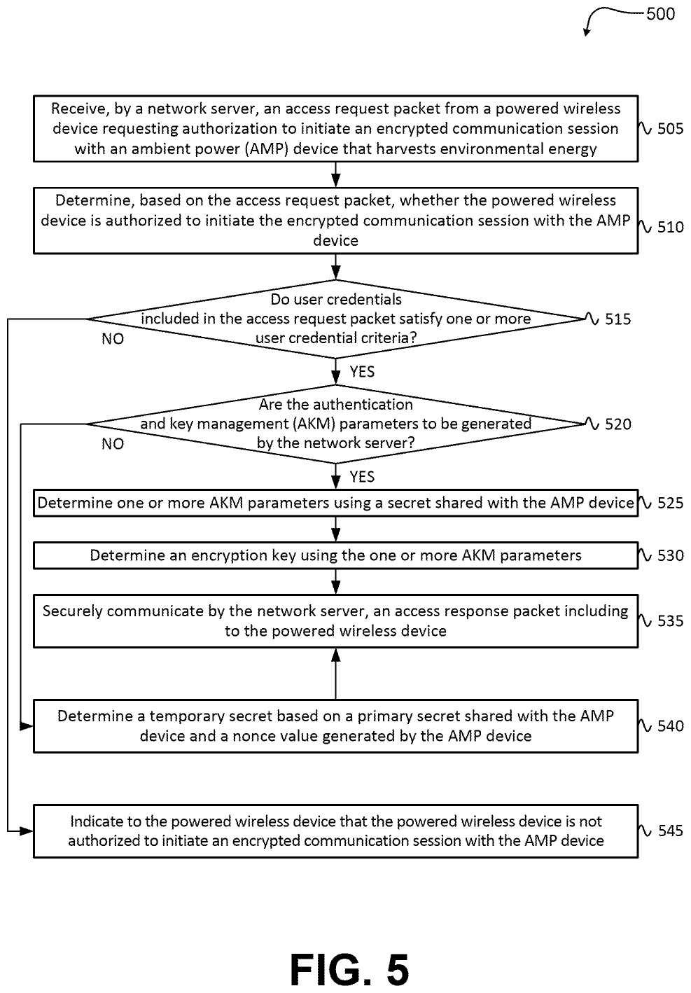

FIG. 5 is a flow diagram of a method 500 for dynamic user access control and credential management in wireless AMP devices, according to still other aspects of the disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. The method 500 can be performed by the wireless network 100, e.g., processing logic of the network server 130.

At operation 505, the processing logic causes the network server to receive an access request packet from a powered wireless device 110. The powered wireless device 110 can be requesting authorization to initiate an encrypted wireless communication session with an AMP device 120 that harvests environmental energy.

At operation 510, the processing logic can determine based on the access request packet, whether the powered wireless device is authorized to initiate the encrypted wireless communication session with the AMP device 120. In some embodiments, the processing logic determines whether a user ID in the access request packet satisfies a user ID criterion. In some embodiments, the processing logic determines whether user credentials associated with the user ID satisfy one or more user credential criterion.

At operation 515, the processing logic can determine whether a user credential included in the access request packet satisfies one or more user credential criteria. If the user credentials do satisfy one or more user credential criteria, the processing logic can proceed to operation 520. If the user credentials do not satisfy one or more user credential criteria, the processing logic can proceed to operation 545.

At operation 520, the processing logic can determine whether the authentication and key management (AKM) parameters are to be generated by the network server. In some embodiments, if the access request packet includes first AKM parameters, the AKM parameters (e.g., second AKM parameters) are to be generated by the network server 130, and the processing logic proceeds to operation 525. In some embodiments, if the access request packet includes a nonce value generated by the AMP device, the AKM parameters are not to be generated by the network server 130, and the processing logic proceeds to operation 540. In many embodiments, the network server 130 can be preconfigured as to whether it will be determining the AKM parameters or not, and thus operation 520 may only be performed initially (e.g., during setup of the network server 130) and not during subsequent performances of the method 500.

At operation 525, responsive to determining the AKM parameters are to be generated by the network server 130, the processing logic can determine one or more AKM parameters using the secret shared between the network server and the AMP device. In some embodiments, the processing logic determines the one or more AKM parameters (e.g., second AKM parameters) using the secret and received AKM parameters (e.g., first AKM parameters).

At operation 530, the processing logic can determine an encryption key using the one or more determined AKM parameters (e.g., the second AKM parameters).

At operation 535, the processing logic can cause the network server 130 to securely communicate an access response packet to the powered wireless device 110. In some embodiments, the access response packet includes the one or more determined AKM parameters and the determined encryption key. In alternative embodiments, the access response packet includes a temporary secret (as described in operation 540).

At operation 540, responsive to determining the AKM parameters are not to be generated by the network server 130, the processing logic determines a temporary secret based on the nonce value generated by the AMP device (included in the access request packet from the powered wireless device 110) and the primary secret shared between the network server 130 and the AMP device 120. After operation 540, the processing logic proceeds to operation 535, where the processing logic causes the network server 130 to securely communicate an access response packet to the powered wireless device 110.

At operation 545, responsive to determining, at operation 515, that the user credentials included in the access request packet do not satisfy one or more user credential criteria, the processing logic can cause the network server 130 to indicate to the powered wireless device 110 that the powered wireless device 110 is not authorized to initiate an encrypted wireless communication session with the AMP device 120.

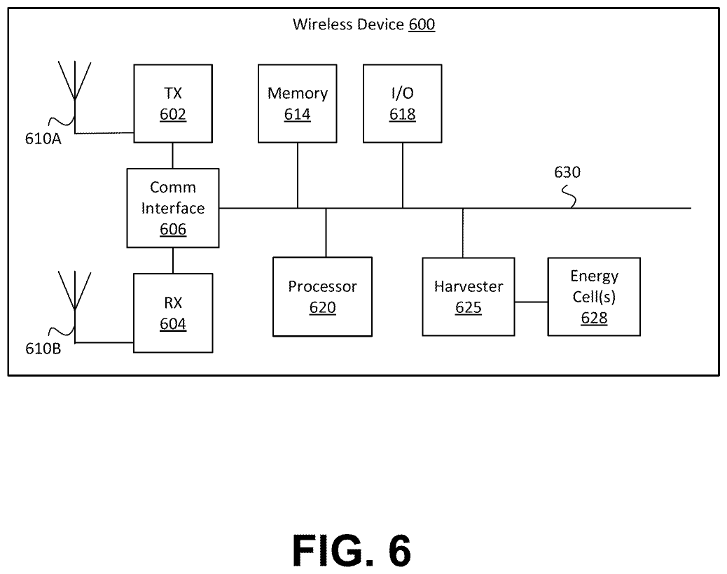

FIG. 6 is a simplified block diagram of an example wireless device 600, which may represent any of the powered wireless device 110 or client wireless devices discussed herein according to aspects of the disclosure. For example, the client wireless devices may include the AMP device 120. In at least some embodiments, the wireless device 600 includes, but is not be limited to, a transmitter 602 or TX (e.g., a WLAN transmitter), a receiver 604 or RX (e.g., a WLAN receiver), a communications interface 606, a TX antenna 610A coupled to the transmitter 602, an RX antenna 610B coupled to the receiver 604, a memory 614, one or more input/output (I/O) devices 618 (such as a display screen, a touch screen, a keypad, and the like), a processor 620, an energy harvester 625, and energy cells 628. These components can all be coupled to a communications bus 630. In some embodiments, aspects of the communication interface 606 work with the processor 620 to perform operations or that function as a processing device of the wireless device 600. In some embodiments, there is a single antenna and multiplexing logic to switch use of the antenna between the TX and RX. In some embodiments, the powered wireless device 110 has no energy harvester, and instead has a battery and/or is analog current (AC)-powered.

In at least some embodiments, the memory 614 includes storage to store instructions executable by the processor 620 and/or data generated by the communication interface 606. In various embodiments, frontend components such as the transmitter 602, the receiver 604, the communication interface 606, and one or more antennas are adapted with or configured for WLAN and WLAN-based frequency bands, e.g., Wi-Fi®, Bluetooth® (BT), Bluetooth® Low Energy (LBE), Ultra-Wideband (UWB), Z-wave™, Zigbee®, LoRa™, Wireless Smart Utility Network® (Wi-SUN®), or other wireless protocol. While some of the protocols may also be referred to as personal area network (PAN) technology, for simplicity, all are broadly referred to as WLAN technology. Future protocols are also envisioned.

In various embodiments, the communications interface 606 is integrated with the transmitter 602 and the receiver 604, e.g., as a frontend of the wireless device 600. The communication interface 606 may coordinate, as directed by the processor 620, to request/receive packets from other wireless devices or those that reflect off of objects. The communications interface 606 can further process data symbols received by the receiver 604 in a way that the processor 620 can perform further processing, including identifying and parsing data packets received within the wireless signals. In some embodiments, the transmitter 602, receiver 604, communication interface 606, and antennas 610A and 610B can be referred to herein as a “wireless communication circuit.”

In various embodiments, the energy harvester 625 performs operations disclosed herein in order to capture electromagnetic or RF signals and other types of non-RF energy, e.g., light, temperature gradients, pressure differential, mechanical vibrations, wind energy, and the like, which were discussed with referenced to FIG. 1A and FIG. 1B. As discussed, the energy harvester 625, with reference to harvesting energy from RF wireless signals, may be a multi-band harvester in being configured to harvest energy from multiple ranges of frequencies that define different RF bands. In these embodiments, the energy harvester 625 is also configured to store the harvested energy within the energy cells 628, which then operate as a power source for the wireless device 600.

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non- transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for Universal Serial Bus (USB) Type-C (USB-C) or USB Power Delivery (PD) mode-transition architecture described herein. The non-transitory computer-readable storage medium may include, but is not limited to, electromagnetic storage medium, read-only memory (ROM), random-access memory (RAM), erasable programmable memory (e.g., Erasable and Programmable Read Only Memory (EPROM) and Electrically Erasable and Programmable Read Only Memory (EEPROM)), flash memory, or another now-known or later-developed non-transitory type of medium that is suitable for storing information.

Although the operations of the circuit(s) and block(s) herein are shown and described in a particular order, in some embodiments the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method comprising:
transmitting, by a powered wireless device, an identification (ID) request frame to an ambient power (AMP) device that harvests environmental energy;
receiving an ID response frame from the AMP device in response to the ID request frame, wherein the ID response frame comprises an ID of the AMP device and a network address of a network server; and
securely communicating, by the powered wireless device using the network address, with the network server to obtain authorization and data from the network server with which to establish an encrypted wireless communication session with the AMP device identified by the ID of the AMP device.

2. The method of claim 1, wherein the ID response frame further comprises one or more first authentication and key management (AKM) parameters, and wherein the securely communicating comprises:
transmitting, by the powered wireless device, an access request packet to the network server, wherein the access request packet includes the ID of the AMP device, at least one of the one or more first AKM parameters, and a user ID corresponding to the powered wireless device; receiving, from the network server, an access response packet including:
one or more second AKM parameters generated by the network server using a primary secret shared between the network server and the AMP device and at least one of the one or more first AKM parameters; and
an encryption key generated by the network server using the one or more second AKM parameters; and
initiating the encrypted wireless communication session with the AMP device using the encryption key generated by the network server.

3. The method of claim 2, wherein initiating the encrypted wireless communication session with the AMP device comprises:
generating a message integrity code (MIC) using a first portion of the encryption key;
generating an encrypted command using a second portion of the encryption key; and
transmitting, by the powered wireless device to the AMP device, a data request frame including the one or more second AKM parameters, the encrypted command, and the MIC.

4. The method of claim 2, further comprising:
receiving a data response frame comprising encrypted data including at least one of status or environmental data associated with the AMP device and a message integrity code (MIC);
verifying the MIC with a first portion of the encryption key;
decrypting the encrypted data with a second portion of the encryption key to generate decrypted data; and
processing the decrypted data.

5. The method of claim 2, wherein the access response packet is transmitted responsive to the user ID satisfying a user ID criterion.

6. The method of claim 2, further comprising, responsive to determining, from the access response packet, that the powered wireless device is not authorized to communicate with the AMP device, terminating a procedure for initiating the encrypted wireless communication session with the AMP device.

7. The method of claim 1, wherein the ID response frame further comprises one or more first authentication and key management (AKM) parameters and a nonce value generated at the AMP device, and wherein the securely communicating comprises:
transmitting, by the powered wireless device, an access request packet to the network server, wherein the access request packet includes the ID of the AMP device, a user ID corresponding to the powered wireless device, and the nonce value generated at the AMP device;
receiving, from the network server, an access response packet including a temporary secret generated by the network server using a primary secret shared with the AMP device and the nonce value;
determining, by the powered wireless device, using the temporary secret and the one or more first AKM parameters, one or more second AKM parameters; and
determining an encryption key using the one or more second AKM parameters; and
initiating the encrypted wireless communication session with the AMP device using the encryption key determined by the powered wireless device.

8. The method of claim 1, wherein the ID response further comprises cyclic redundancy check (CRC) data, the method further comprising, in response to failing to verify the CRC data, terminating a procedure of establishing an authenticated and encrypted communication session between the powered wireless device and the AMP device.

9. A method comprising:
receiving, by an ambient power (AMP) device that harvests environmental energy, an identification (ID) request frame from a powered wireless device, wherein the ID request frame includes an authentication and key management (AKM) method;
retrieving, from memory, a secret that is shared with a network server, wherein the network server is communicatively coupled with the powered wireless device;
determining, using the secret, one or more first AKM parameters associated with the AKM method; and
transmitting, to the powered wireless device, by the AMP device, an ID response frame comprising an ID of the AMP device, a network address of the network server, and the one or more first AKM parameters with which the powered wireless device is to be authorized by the network server to initiate an encrypted wireless communication session with the AMP device.

10. The method of claim 9, wherein the network address is stored in the memory of the AMP device, the method further comprising retrieving the network address from the memory.

11. The method of claim 9, wherein the ID request frame includes one or more frame-exchange parameters and a checksum value, the method further comprising:
including, in the ID response frame, at least one of the one or more frame-exchange parameters;
verifying whether the checksum value is correct; and
in response to failing to verify the checksum value, terminating a procedure of establishing the encrypted wireless communication session with the AMP device.

12. The method of claim 9, further comprising:
receiving a data request frame from the powered wireless device, the data request frame including one or more second AKM parameters generated by the network server, an encrypted command, and a first message integrity code (MIC);
determining an encryption key using the one or more first AKM parameters and the one or more second AKM parameters;
verifying the first MIC with a first portion of the encryption key;
decrypting the encrypted command with a second portion of the encryption key to generate a decrypted command; and
executing the decrypted command.

13. The method of claim 12, wherein executing the decrypted command comprises:
generating a second MIC using the first portion of the encryption key;
generating encrypted data comprising at least one of status or environmental information retrieved from a coupled sensor using the second portion of the encryption key; and
transmitting, to the powered wireless device, by the AMP device, a data response frame comprising the second MIC and the encrypted data.

14. The method of claim 9, further comprising generating, by the AMP device, a nonce value to be used by the network server to verify an access request packet transmitted by the powered wireless device to the network server, wherein the ID response frame further comprises the nonce value.

15. The method of claim 14, further comprising:
receiving a data request frame from the powered wireless device, the data request frame including one or more second AKM parameters generated by the powered wireless device using information received from the network server, an encrypted command, and a message integrity code (MIC);
determining an encryption key using the one or more first AKM parameters and the one or more second AKM parameters;
verifying the MIC with a first portion of the encryption key;
decrypting the encrypted command with a second portion of the encryption key to generate a decrypted command; and
executing the decrypted command.

16. The method of claim 9, wherein the ID response frame further comprises cyclic redundancy check (CRC) data to be used by the powered wireless device to verify information in the ID response frame.

17. A method comprising:
receiving, by a network server, an access request packet from a powered wireless device requesting authorization to initiate an encrypted wireless communication session with an ambient power (AMP) device that harvests environmental energy;
responsive to determining, based on the access request packet, that the powered wireless device is authorized to initiate the encrypted wireless communication session with the AMP device:
determining one or more first authorization and key management (AKM) parameters based on at least a primary secret shared with the AMP device; and
determining an encryption key using the one or more first AKM parameters; and
securely communicating, by the network server, an access response packet to the powered wireless device, the access response packet including the one or more first AKM parameters and the encryption key.

18. The method of claim 17, wherein the access request packet includes a nonce value generated by the AMP device, the method further comprising:
responsive to determining that the powered wireless device is authorized to initiate the encrypted wireless communication session with the AMP device, determining a temporary secret based on at least the primary secret shared with the AMP device and the nonce value; and
securely communicating, by the network server, the access response packet to the powered wireless device, the access response packet including the temporary secret.

19. The method of claim 17, wherein the access request packet comprises one or more received AKM parameters, wherein determining the one or more first AKM parameters is based on the primary secret shared with the AMP device and the one or more received AKM parameters.

20. The method of claim 17, wherein the access request packet comprises one or more user credentials corresponding to the powered wireless device, the method further comprising:
determining whether the one or more user credentials satisfy at least one of one or more user credential criteria; and
including an indicator reflecting that the powered wireless device is authorized to communicate with the AMP device in the access response packet.

21. The method of claim 17, further comprising, responsive to determining, based on the access request packet, that the powered wireless device is not authorized to initiate the encrypted wireless communication session with the AMP device, terminating a procedure of establishing the encrypted wireless communication session between the powered wireless device and the AMP device.
